(19) United States
(12) Patent Application Publication
(10) Pub. No.: US 2007/0175694 A1
(43) Pub. Date: Aug. 2, 2007

(54) Disconnect Actuator

(75) Inventors: William H. Fort, Stratham, NH (US); William Farmer, Chelmsford, MA (US); Eric Beishline, Marlborough, MA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: STONERIDGE CONTROL DEVICES, INC., Canton, MA (US)

(21) Appl. No.: 11/564,236

(22) Filed: Nov. 28, 2006

Related U.S. Application Data
(60) Provisional application No. 60/740,032, filed on Nov. 28, 2005.

(51) Int. Cl. B60K 17/00

(52) U.S. Cl. 180/337

(57) ABSTRACT

An actuator for selectively coupling first and second shafts for transmitting torque between the first and second shafts and a system incorporating the same. The actuator includes a sleeve movable between engaged and disengaged positions. An armature is configured to move the sleeve into an engaged position in response to energization of a coil. A latching mechanism may hold the sleeve in the engaged position when the coil is deenergized.

### CROSS-REFERENCE TO RELATED APPLICATIONS

The present application claims the benefit of the filing date of U.S. Provisional Application Ser. No. 60/740,032, filed Nov. 28, 2005, the teachings of which are hereby incorporated herein by reference.

### FIELD

The present disclosure is directed at electromechanical actuators, and more particularly at an actuator for selectively connecting/disconnecting torque delivery.

### BACKGROUND

In recent years, commercial vehicles, sport utility vehicles and passenger vehicles capable of full-time or part-time 4-wheel drive and/or all-wheel-drive operation have become commonplace. In some configurations, the operator has the option of selecting 2-wheel or 4-wheel drive depending on the conditions at any given time. The vehicle may also, or alternatively, be configured to automatically move from one drive train or suspension operating condition to another condition based on road conditions sensed by the vehicle. For example, the vehicle may move from 2-wheel drive to 4-wheel drive, or may selectively drive particular wheels, when slippery road conditions are encountered. Connection and disconnection of a vehicle suspension stabilizer may also be established, either manually or automatically, due to road conditions.

To establish these changes in drive train or suspension operating conditions, a vehicle may be equipped with one or more electromechanical actuators, e.g. for changing the state of the front and/or rear differential, transfer case, and/or stabilizer bar system. Cost and reliability of such actuators are, of course, important considerations. There is thus a continuous need for cost-effective and reliable vehicle gear box shift actuators.

### BRIEF DESCRIPTION OF THE DRAWINGS

Features and advantages of the present disclosure are set forth by description of embodiments consistent therewith, which description should be considered in conjunction with the accompanying drawings, wherein:

FIG. 1 is a partially transparent plan view of an embodiment of an actuator consistent with the present disclosure;

FIG. 2-5 illustrate the operation of the actuator of FIG. 1 moving between a disengaged and an engaged condition; and

FIGS. 6-10 illustrate the operation of the actuator of FIG. 1 moving between an engaged and a disengaged condition.

### DESCRIPTION

An actuator consistent with the disclosure may suitably be employed in any application for connecting and/or disconnecting two components, e.g., two shafts, etc., for the transmission of torque therebetween. For example, an actuator herein may be employed in connection with the operation of a gear box, such as a transfer case of a 4-wheel drive vehicle, vehicle front differential, vehicle rear differential, transmission, etc. It will be appreciated, however, that an actuator consistent with the disclosure will be useful in connection with a variety of applications in and out of vehicles, such as stabilizer bars, parking brakes, interlocks, etc. It is to be understood, therefore, that illustrated exemplary embodiments described herein are provided only by way of illustration, and are not intended to be limiting.

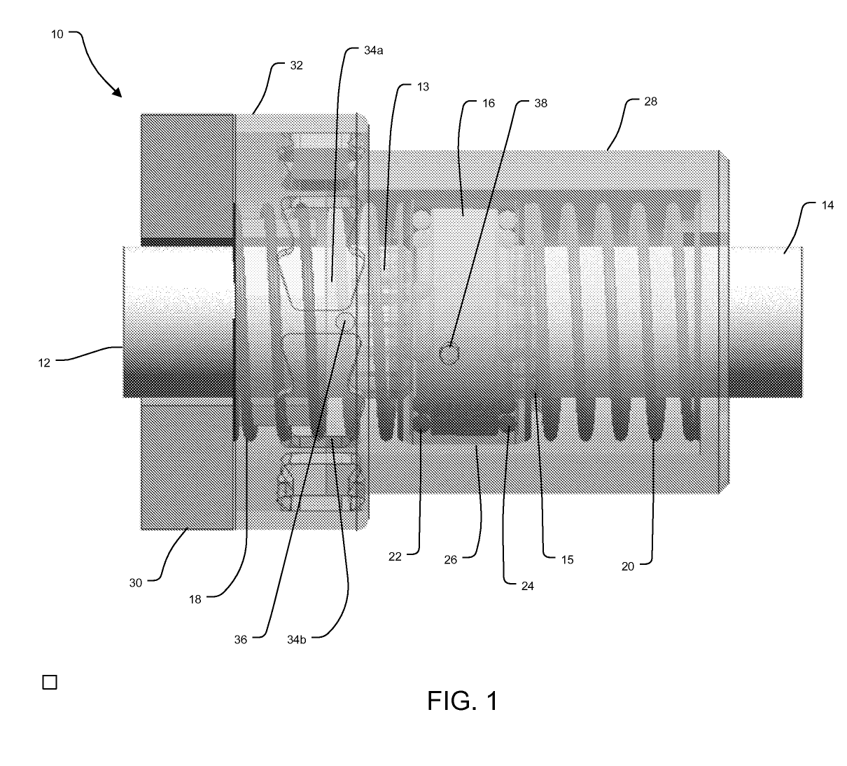

Referring to FIG. 1, an actuator 10 is provided for selectively coupling two shafts 12, 14 for transmitting torque therebetween. As shown, adjacent ends of each shaft 12, 14 may include respective splined regions 13, 15. The actuator 10 may include a sleeve 16 which may be slidably disposed relative to the two shafts 12, 14. In the illustrated exemplary embodiment, the sleeve is generally cylindrical and is configured for at least partially receiving the ends of the respective shafts in a central opening therein. In one embodiment, the sleeve 16 may include an internal spline configured to engage the respective external splines 13, 15 of the two shafts 12, 14 in a torsionally rigid manner. When the sleeve 16 is slidably disposed to at least partially engaged both shafts 12, 14, the two shafts 12, 14 may be coupled in a torsionally rigid manner. Conversely, when the sleeve 16 is disposed to engage only one shaft 14, the two shafts 12, 14 may be disconnected, i.e., torque may not be transmitted from one shaft to the other.

The sleeve 16 may be captured between a return spring 18 and a blocked spline spring 20. The shafts 12, 14 may extend at through central openings in the respective springs 18, 20, as shown. Respective thrust bearings 22, 24 may be disposed between the sleeve 16 and the return spring 18 and the blocked spline spring 20 to permit the sleeve 16 to rotate independently of the springs 18, 20. As shown, in one embodiment, the sleeve 16 and thrust bearings 22, 24 may be at least partially disposed in a non-rotating cage 26. As shown, the thrust bearings 22, 24 may include a plurality of ball bearings. As such, the sleeve 16 may be rotatably disposed within the cage 26 and between the thrust bearings 22, 24. Alternative thrust bearing and/or cage arrangements may be employed for rotatably capturing the sleeve between the return spring and the blocked spline spring.

The actuator 10 may further include an armature 28 and a coil 30. When the coil 30 is energized, the armature 28 may be urged toward the coil 30, e.g. in a manner such as in a conventional solenoid configuration. When the coil 30 is energized to urge the armature 28 toward the coil 30, the armature 28 may urge the sleeve 16 toward the coil 30, e.g., by way of the blocked spline spring 20 acting against the cage 26. The blocked spline spring 20 may be stiffer than the return spring 18, e.g., may have a higher spring constant. Accordingly, absent a blocked condition, when the coil 30 is energized the armature 28 may move the sleeve 16 toward the coil 30, i.e., toward an engaged condition. The blocked spline spring 20 may remain generally uncompressed and/or compressed to a lesser degree than the return spring 18 when the sleeve 16 is moved toward the engaged condition.

The blocked spline spring 20 may provide for initial misalignment of the splines 13, 15 of the shafts 12, 14 when the actuator 10 is energized. For example, if the splines 13, 15 are initially misaligned, the sleeve 16 may be blocked from sliding to at least partially engage the splines 13, 15 of both shafts 12, 14. In such a situation the blocked spline spring 20 may be compressed by the armature 28 as the armature 28 moves toward the coil 30 when the coil 30 is energized. As the shafts 12, 14 rotate relative to one another the respective splines 13, 15 may align with one another, thereby clearing the blocked condition. When the blocked condition is cleared, e.g., by alignment of the splines 13, 15, the blocked spline spring 20 may slidingly drive the sleeve 16 to at least partially engage the splines 13, 15 of each of the shafts 12, 14, thereby coupling the shafts 12, 14 for transmitting torque therebetween.

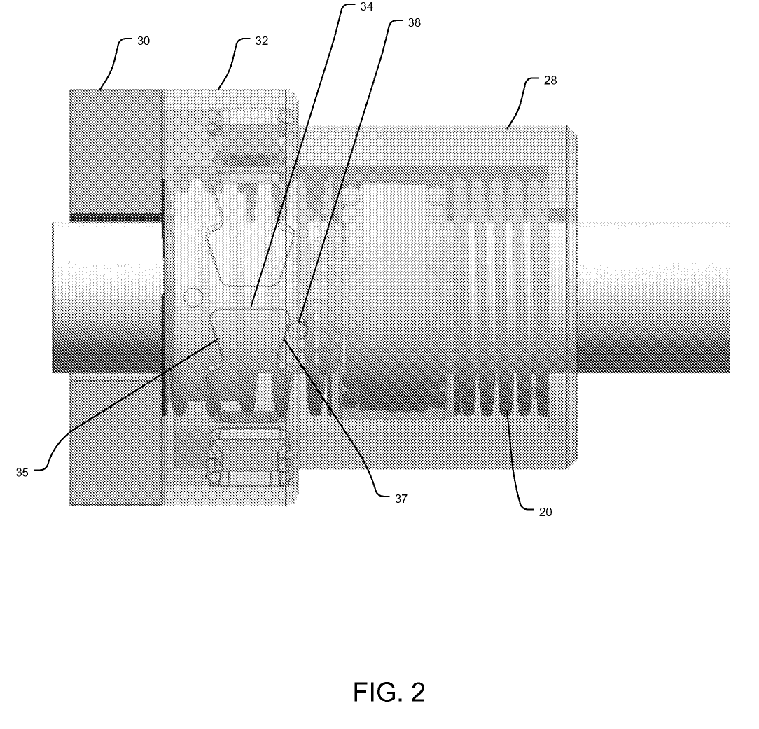

According to one aspect, the actuator 10 may be maintained in an engaged condition, i.e., with the sleeve 16 coupling the two shafts 12, 14 for transmission of torque therebetween, without requiring a holding current. The actuator may be maintained in an engaged condition using a push-push latching device. In one embodiment, the push-push latching device may include an indexing collar 32 rotatably coupled relative to the armature 28. In an embodiment, the indexing collar 32 may be rotatably coupled to the coil 30. Alternatively, the indexing collar may be coupled to other features, e.g., a housing, of the actuator. The indexing collar 32 may include a series of cam features 34, e.g., double converging cam features as shown, spaced around the circumference of the indexing collar 32. Each cam feature 34 may include a near-side cam face 35 and a far-side cam face 37, as shown in FIG. 2. The push-push latching device may also include at least two indexing features, e.g., indexing pins 36, 38, associated with the armature 28.

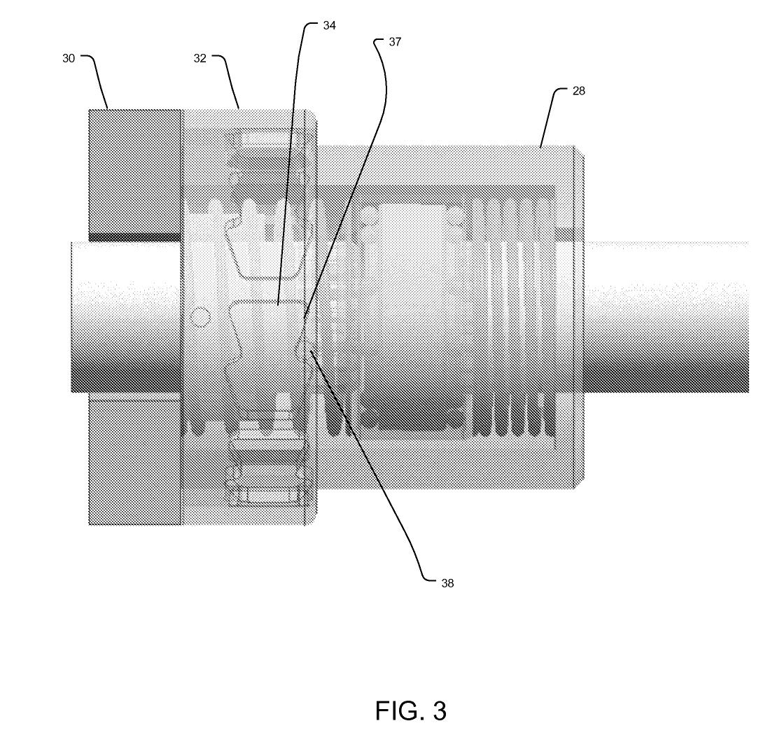

Referring to FIGS. 2 through 5, the operation of the actuator from the fully disengaged condition of FIG. 1 to a fully engaged condition is shown. When the coil 30 is energized the armature 28 may move toward the coil 30. As the armature 28 moves toward the coil 30 one indexing pin 36, 38 may be disposed on either side of the cam features 34. The far-side indexing pin 38 may engage a far-side cam face 37 of the cam feature 34. As the armature 28 continues to move toward the coil 30, engagement between the indexing pin 38 and the far-side cam face 37 may rotate the indexing collar 32 relative to the indexing pin 38, e.g., in an upward direction of the depicted view of FIG. 3. If the splines 13, 15 of the two shafts 12, 14 are misaligned, resulting in a blocked condition, the blocked spline spring 20 may be compressed. The blocked spline spring 20 may at least partially compress even if no blocked condition exists.

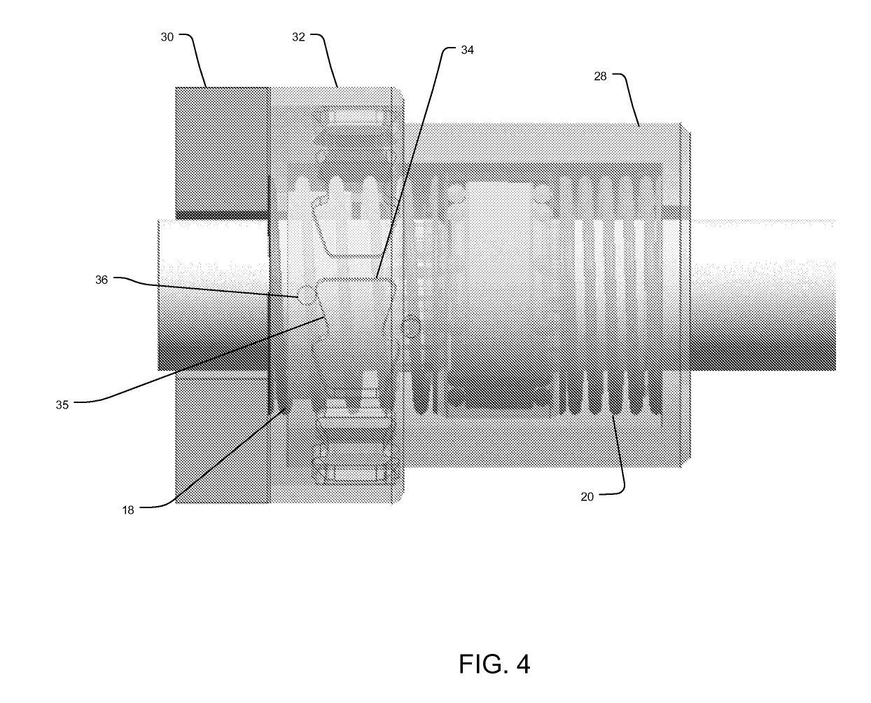

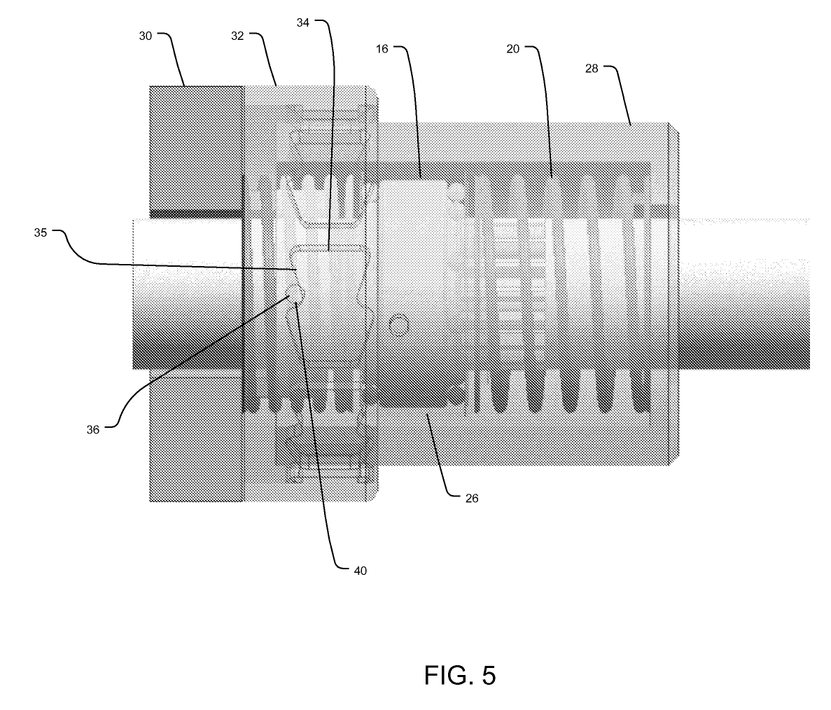

Turning to FIG. 4, when the coil 30 is de-energized the armature 28 may be urged toward a disengaged state, i.e., toward a position away from the coil 30, by the return spring 18 and/or by the blocked spline spring 20. As the armature 28 moves toward the disengaged state, the near-side indexing pin 36 may engage the near-side cam face 35 of the cam feature 34. As shown in FIG. 5, as the armature 28 travels toward a disengaged state, the interaction of the near-side indexing pin 36 and the near-side cam face 35 of the cam feature 34 may rotate the indexing collar 32, e.g., in an upward direction in the illustrated view. The near-side indexing pin 36 may be disposed in an engaged pocket 40 of the cam feature 34, thereby retaining the armature 28 in an engaged condition.

The blocked condition spring 20 may bear against the sleeve 16, e.g., via the collar 26, to slidingly drive the sleeve 16 to engage the splines of the shafts 12, 14 to couple the shafts 12, 14 for transmitting torque therebetween. In the event of a blocked condition, the blocked spline spring 20 may remain compressed even after the coil 30 is de-energized, e.g., the engagement of the near-side indexing pin 36 and the cam feature 34, e.g., the engaged pocket 40 of the cam feature 34, may maintain the armature 28 in an engaged condition. When the blocked condition is cleared, e.g., by the alignment of the splines of the shafts 12, 14, the blocked spline spring 20 may slidingly drive the sleeve 16 to engage the splines of both shafts 12, 14 to couple the shafts 12, 14 for transmitting toque therebetween. If not blocked condition exists, the blocked spline spring 20 may drive the sleeve 16 directly to an engaged condition.

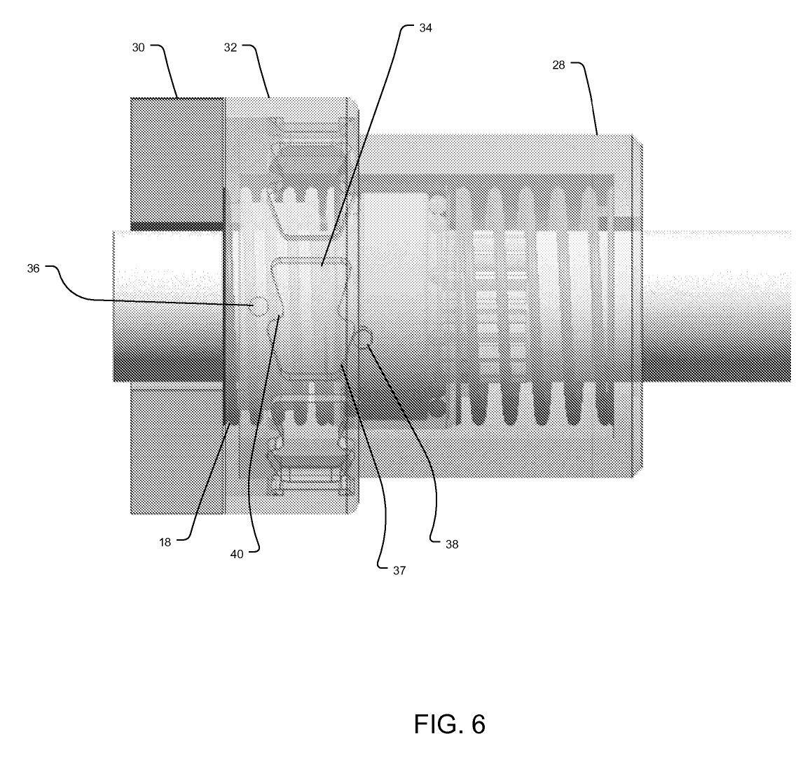

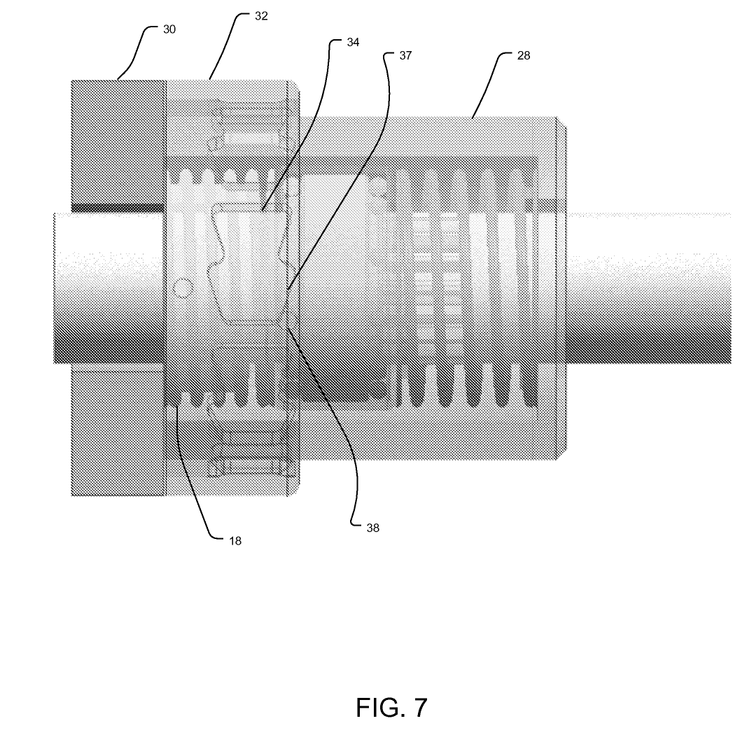

The actuator 10 may be disengaged, e.g., to uncouple the shafts 12, 14 from one another to prevent transmitting torque between the two shafts 12, 14. Referring to FIGS. 6 and 7, from an engaged condition, the actuator 10 may be disengaged by energizing the coil 30 to urge the armature 28 toward the coil 30 against the bias of the return spring 18. As the armature 28 moves toward the coil 30, the near-side indexing pin 36 may be released from the engaged pocket 40 of the cam feature 34, and the far-side indexing pin 38 may engage the far-side cam face 37 of the cam feature 34. As shown in FIG. 7, interaction between the far-side indexing pin 38 and the far-side cam face 37 of the cam feature 34 may rotate the indexing collar 32, e.g., in an upward direction in the depicted view.

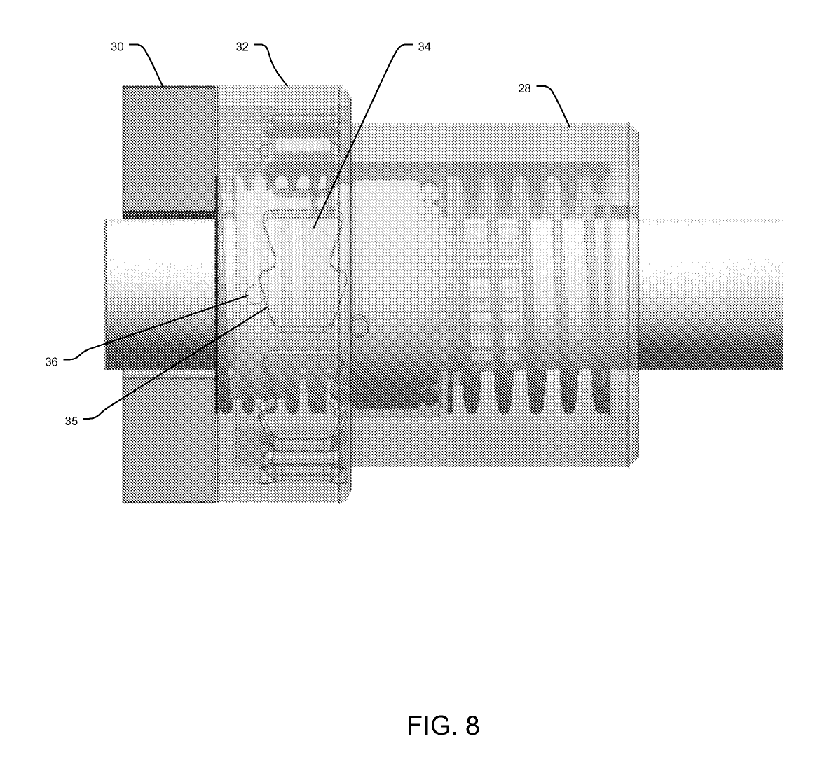

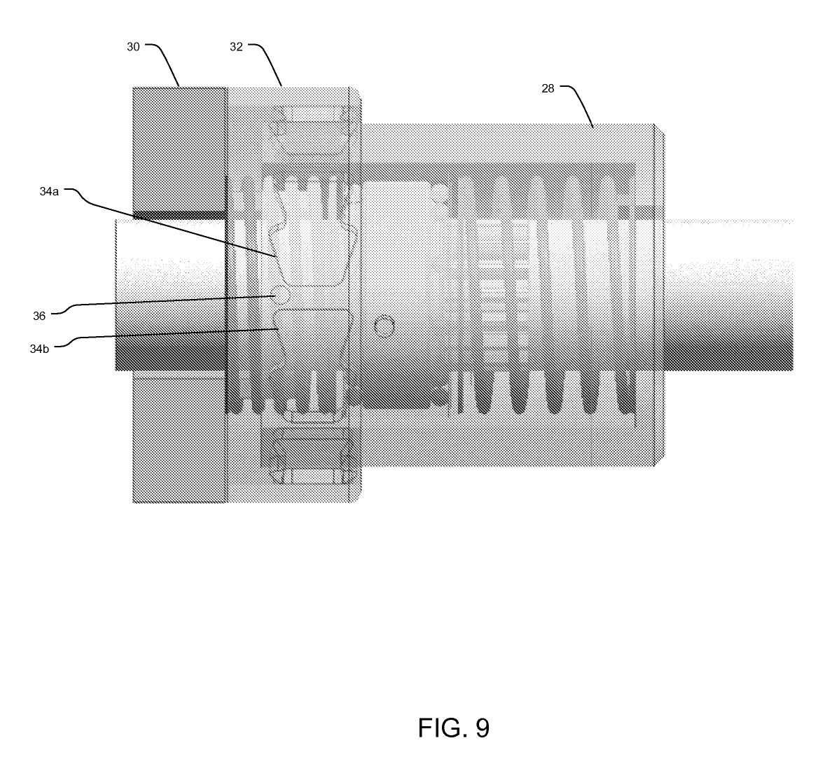

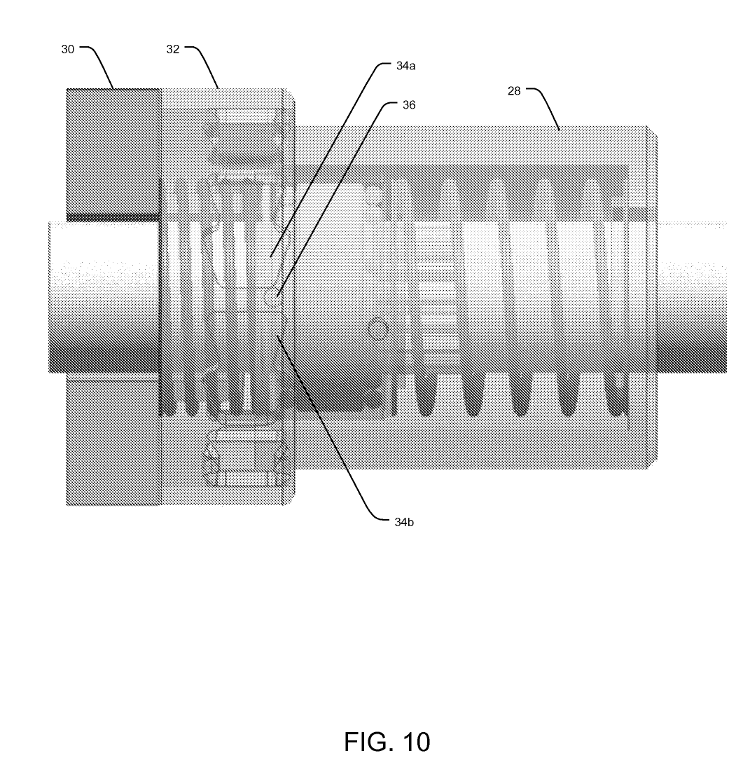

With additional reference to FIG. 8, when the coil 30 is de-energized the armature 28 may move toward a disengaged condition under the bias of the return spring 18 and/or the blocked spline spring 20. As the armature 28 moves toward the disengaged condition, the near-side indexing pin 36 may engaged the near-side cam surface 35 of the cam feature 34. Interaction between the near-side indexing pin 36 and the near-side cam surface 35 may continue to rotate the indexing collar 32 relative to the near-side indexing pin 36, e.g., in an upward direction in the illustrated view. As shown in FIG. 9, the indexing collar 32 may be rotated until the near-side indexing pin 36 is aligned with an opening between two adjacent cam features 34a, 34b. As shown in FIG. 10, the armature 28 may continue to move to a fully disengaged condition, e.g., under the bias of the return spring 18. In the fully disengaged condition the near-side indexing pin 36 may be at least partially disposed between adjacent cam features 34a, 34b. The sleeve 16 may also be moved to a disengaged condition, i.e., not coupling the two shafts 12, 14 for transmitting torque therebetween, by the movement of the armature to the disengaged condition and/or by the bias of the return spring 18.

Consistent with the foregoing disclosure, an actuator may be provided for releasably coupling two features, such as shafts, for the transmission of torque therebetween. The actuator may be maintained in an engaged condition without the need for a holding current using a push-push latching device. The push-push latching device may include an indexing feature, such as an indexing collar, and cooperating indexing features associated with an armature. As an actuating coil of the actuator is repeatedly energized the indexing features of the armature may interact with the indexing feature to maintain the armature in an engaged condition or release the armature to a disengaged condition. Accordingly, operation of the actuator may employ simple control electronics, such as a simple momentary switch, for the operation of the actuator. Such an actuator may be compact and low cost to manufacture, and may accommodate blocked condition.

According to one aspect of the disclosure, there is provided an actuator for selectively coupling first and second shafts for transmitting torque between the first and second shafts. The actuator includes a sleeve configured movable between engaged and disengaged positions relative to the first and second shaft, the sleeve coupling the first and second shafts for transmission of torque therebetween in the engaged position and being decoupled from at least one of the first and second shafts in the disengaged position; a coil; an armature responsive to the coil, the armature being configured to force the sleeve into the engaged position upon energization of the coil.

According to another aspect of the disclosure there is provided a system including a first shaft; a second shaft; sleeve configured movable between engaged and disengaged positions relative to the first and second shafts, the sleeve coupling the first and second shafts for transmission of torque therebetween in the engaged position and being decoupled from at least one of the first and second shafts in the disengaged position; a coil; and an armature responsive to the coil, the armature being configured to force the sleeve into the engaged position upon energization of the coil.

Other aspects are set forth in the preceding description and associated drawings. The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. All such variations and combinations are contemplated within the scope of the present invention. Other modifications, variations, and alternatives are also possible. Accordingly, the claims are intended to cover all such equivalents.

What is claimed is:

1. An actuator for selectively coupling first and second shafts for transmitting torque between the first and second shafts, said actuator comprising:
a sleeve configured movable between engaged and disengaged positions relative to said first and second shaft, said sleeve coupling said first and second shafts for transmission of torque therebetween in said engaged position and being decoupled from at least one of said first and second shafts in said disengaged position;
a coil; and
an armature responsive to said coil, said armature being configured to force said sleeve into said engaged position upon energization of said coil.

2. An actuator according to claim 1, said actuator further comprising:
a first spring positioned on a first side of said sleeve; and
a second spring positioned on a second side of said spring.

3. An actuator according to claim 2, at least one of said springs being a blocked spline spring for providing a biasing force against said sleeve when said sleeve is blocked from moving to said engaged position due to interference between said sleeve and at least one of said shafts and to force said sleeve into said engaged position when said interference is cleared.

4. An actuator according to claim 2, at least one of said springs being a return spring for providing a biasing force against said sleeve to force said sleeve toward said disengaged position.

5. An actuator according to claim 2, wherein said first shaft extends into a central opening in said first spring and said second shaft extends into a central opening in said second spring.

6. An actuator according to claim 1, said actuator further comprising:
a latching device for releasably latching said sleeve in said engaged position when said coil is deenergized.

7. An actuator according to claim 1, wherein said first and second shafts are configured to extend into a central opening in said sleeve.

8. An actuator according to claim 1, wherein said armature is configured to move toward said coil upon energization of said coil.

9. An actuator for selectively coupling first and second shafts for transmitting torque between the first and second shafts, said actuator comprising:
a sleeve configured movable between engaged and disengaged positions relative to said first and second shaft, said sleeve coupling said first and second shafts for transmission of torque therebetween in said engaged position and being decoupled from at least one of said first and second shafts in said disengaged position;
a first spring positioned on a first side of said sleeve;
a second spring positioned on a second side of said spring;
a coil;
an armature responsive to said coil, said armature being configured to force said sleeve into said engaged position upon energization of said coil; and
a latching device for releasably latching said sleeve in said engaged position when said coil is deenergized.

10. An actuator according to claim 9, at least one of said springs being a blocked spline spring for providing a biasing force against said sleeve when said sleeve is blocked from moving to said engaged position due to interference between said sleeve and at least one of said shafts and to force said sleeve into said engaged position when said interference is cleared.

11. An actuator according to claim 9, at least one of said springs being a return spring for providing a biasing force against said sleeve to force said sleeve toward said disengaged position.

12. An actuator according to claim 9, wherein said armature is configured to move toward said coil upon energization of said coil.

13. A system comprising
a first shaft;
a second shaft;
a sleeve configured movable between engaged and disengaged positions relative to said first and second shafts, said sleeve coupling said first and second shafts for transmission of torque therebetween in said engaged position and being decoupled from at least one of said first and second shafts in said disengaged position;
a coil; and
an armature responsive to said coil, said armature being configured to force said sleeve into said engaged position upon energization of said coil.

14. A system according to claim 13, said actuator further comprising:
a first spring positioned on a first side of said sleeve; and
a second spring positioned on a second side of said spring.

15. A system according to claim 14, at least one of said springs being a blocked spline spring for providing a biasing force against said sleeve when said sleeve is blocked from moving to said engaged position due to interference between said sleeve and at least one of said shafts and to force said sleeve into said engaged position when said interference is cleared.

16. A system according to claim 14, at least one of said springs being a return spring for providing a biasing force against said sleeve to force said sleeve toward said disengaged position.

17. A system according to claim 14, wherein said first shaft extends into a central opening in said first spring and said second shaft extends into a central opening in said second spring.

18. A system according to claim 13, said actuator further comprising:
a latching device for releasably latching said sleeve in said engaged position when said coil is deenergized.

19. A system according to claim 13, wherein said first and second shafts are configured to extend into a central opening in said sleeve.

20. A system according to claim 13, wherein said armature is configured to move toward said coil upon energization of said coil.
